(19) United States
(12) Patent Application Publication
(10) Pub. No.: US 2013/0322388 A1
(43) Pub. Date: Dec. 5, 2013

(54) DEVICE-TO-DEVICE COMMUNICATION AND TERMINAL RELAY METHOD

(71) Applicants: Jae-Young Ahn, Daejeon (KR); Tae Gyun Noh, Daejeon (KR); Young Jo Ko, Daejeon (KR)

(72) Inventors: Jae-Young Ahn, Daejeon (KR); Tae Gyun Noh, Daejeon (KR); Young Jo Ko, Daejeon (KR)

(21) Appl. No.: 13/976,202

(22) PCT Filed: Dec. 27, 2011
(86) PCT No.: PCT/KR11/10170

§ 371 Date: Aug. 22, 2013

(30) Foreign Application Priority Data
Dec. 27, 2010 (KR) 10-2010-0135220

(51) Int. Cl. H04W 76/02

(52) U.S. Cl. CPC H04W 76/023
USPC 370/329

(57) ABSTRACT

Disclosed are a method for checking whether D2D communication between devices for performing D2D communication is possible, and a method for estimating the proximity of devices to base stations and the proximity of devices to one another for reusing wireless resources in device-to-device communication and terminal relay communication. The method according to the present invention may enable the verification of whether D2D communication is possible between devices to establish a D2D connection, and may enable the wireless resources allocated to a cellular link and to other D2D links to be reused. Further, the method of the present invention may enable variations in a link state caused by terminal mobility to be handled, as well as D2D communication between new UEs and D2D communication between a new UE and a legacy UE, to be handled.

### TECHNICAL FIELD

The present invention relates to direct device-to-device (D2D) communication and user equipment (UE) relaying, and more particularly to a direct D2D communication method, a UE relaying method, a method of confirming whether or not the D2D communication is possible and a method of identifying other terminals close to a terminal performing D2D communication for performing the former two methods.

### BACKGROUND ART

Direct device-to-device (D2D) communication refers to communication in which direct data transmission and reception is performed between two adjacent terminals without the data passing through a base station. That is, the two terminals act as source and destination of the data to perform communication, respectively.

Direct D2D communication may be performed using unlicensed bands such as Bluetooth or wireless LAN such as IEEE802.11. However, it is difficult to provide a scheduled and controlled service in the communication using the unlicensed band. In particular, performance may be rapidly deteriorated due to interference. On the other hand, in the case of direct D2D communication provided by the wireless communication system using licensed bands or TV white space bands managed in an environment where inter-system interference is controlled, quality of service (QoS) can be supported, frequency use efficiency can be enhanced through frequency reuse, and a communication-enabled distance can be increased.

Meanwhile, UE relaying communication refers to communication in which a nearby terminal (terminal B) having a good link characteristic with a nearby base station, that is, located closer to the base station or located out of a shaded area, relays data between terminal A and the base station in order to increase the transmission capacity of the terminal (terminal A) located at a cell boundary or the shaded area. In this case, terminal A may act as the source and/or destination of data.

The UE relaying can improve the transmission capacity of the terminal located at the cell boundary and can enhance the frequency use efficiency of the entire cell through the frequency reuse.

In this case, a D2D link is required in common with both the direct D2D communication and the UE relaying communication. The D2D link is a link in which terminals belonging to the same cell or other cells directly exchange data without the data passing through a network in cellular communication.

Here, only the D2D link is created between two terminals in the case of direct D2D communication, and a cellular link between the base station and the relay terminal (terminal B) and the D2D link between the relay terminal (terminal B) and the end terminal (terminal A) are created in the case of UE relaying communication.

In order to apply the direct D2D communication described above to the current cellular communication system, a method of confirming whether the D2D link can be created between terminals trying to perform communication and a method of identifying other terminals close to the D2D communication terminals for frequency reuse are required.

In addition, in order to apply the UE relaying communication described above to the current cellular communication system, a method of selecting a terminal that should act as the relay and a method of identifying other terminals close to the relay terminal and the end terminal for frequency reuse in the D2D link for relaying are required.

### DISCLOSURE

### [Technical Problem]

An object of the present invention is to provide a method of operating a network including a base station for direct D2D communication.

Another object of the present invention is to provide a method of operating a terminal for direct D2D communication and UE relaying communication, in particular, a method of identifying whether or not the D2D communication is possible or confirming the closeness between terminals available for allocating resources to be used for the D2D communication.

Another object of the present invention is to provide a method of operating a base station for direct D2D communication and UE relaying communication, in particular, a method of operating the base station that allocates wireless resources to the D2D link based on the closeness between the base station and terminals and the closeness between the terminals.

Another object of the present invention is to provide a method of operating a base station for UE relaying communication.

### [Technical Solution]

According to an example for achieving the object of the present invention described above, there is provided a method of operating a network for direct device-to-device (D2D) communication, including: (a) requesting, by the network, serving cell base station(s) of first and second terminals to confirm D2D communication possibility between the first and second terminals in response to a connection setting request for the second terminal from the first terminal, or in accordance with self-determination of the network when the connection between the first and second terminals has been already created; (b) determining, by the serving cell base station(s), whether or not the D2D communication between the first and second terminals is possible; (c) setting a D2D connection between the first and second terminals; (d) identifying the closeness between the first and second terminals and base stations and the closeness between the first and second terminals and terminals close to the first and second terminals; and (e) allocating wireless resources for the D2D communication between the first and second terminals based on the closeness identified in (d) in accordance with a resource allocation request of at least one of the first and second terminals.

(b) determining whether or not the D2D communication between the first and second terminals is possible may include determining whether or not the D2D communication between the first and second terminals is possible based on the closeness between the first and second terminals. In this case, the closeness between the first and second terminals may be determined based on at least one of position information reported by the first and second terminals, position information of the first and second terminals measured by the network, reception quality information of a sounding reference signal (SRS) that is transmitted by one of the first and second terminals and received by the other of the first and second terminals, and reception quality information reported by one of the first and second terminals on data that is transmitted through an uplink or downlink physical resource block (PRB) by the other of the first and second terminals.

In (d), the closeness between the base stations and the first and second terminals may be identified based on at least one of reception quality information of the terminals with respect to a downlink signal transmitted by the base station, uplink channel status information of the SRS received from the terminal, and reception quality information of a signal from adjacent base stations that is measured and reported by each terminal for handover, etc., or may be identified based on position information reported to the base station by the terminals or position information measured on the terminal by the network.

In (d), the closeness between the first and second terminals and the terminals close to the first and second terminals may be identified using position information reported by the terminals or position information of the terminals measured by the network, or may be identified by the network based on reception quality reported to the network by one of the terminals with respect to data mapped to an uplink control channel sequence and/or uplink PRB and transmitted by the other terminal or based on reception quality reported to the network by one of the terminals with respect to data mapped to a downlink PRB and transmitted by the other terminal

Here, (e) allocating the wireless resources for the D2D communication may include receiving a reception quality report from at least one of the first and second terminals with respect to an uplink or downlink PRB allocated to another D2D link that has been already set, and determining the resources to be allocated to the D2D link based on the reported reception quality.

According to another example for achieving the object of the present invention described above, there is provided a method of operating a terminal used to identify whether or not D2D communication is possible and/or nearby terminals for direct D2D communication and UE relaying communication, including: (a) receiving an uplink signal or a downlink signal transmitted by a counterpart terminal constituting a D2D link; (b) reporting, to a base station, reception quality of the uplink signal or the downlink signal transmitted by the counterpart terminal; and (c) receiving, from the base station, connection setting of the D2D link and resource allocation of the D2D link based on the reception quality reported to the base station.

In (a), the uplink signal or the downlink signal transmitted by the counterpart terminal may be at least one of an uplink SRS, an uplink physical uplink control channel (PUCCH) signal and data using a designated uplink/downlink PRB. In this case, in (b), when the terminal receives an uplink PUCCH transmitted by the counterpart terminal, reception quality per sequence of the PUCCH along with a subframe ID that has received the uplink PUCCH may be reported to the base station. In this case, in (b), when the terminal receives the data using the uplink or downlink PRB transmitted by the counterpart terminal, a subframe ID that has received the data using the uplink or downlink PRB along with reception quality of the data may be reported to the base station.

According to another example for achieving the object of the present invention described above, there is provided a method of determining D2D link resources of a serving cell base station for direct D2D communication and UE relaying communication, including: (a) determining the closeness between the base station and at least one terminal; (b) determining the closeness between nearby terminals of the at least one terminal; and (c) determining the D2D link resources based on the information obtained in (a) and (b).

Here, (a) determining the closeness between the base station and the at least one terminal may include determining the closeness between the base station and the at least one terminal based on at least one of a reception signal quality information report of the at least one terminal with respect to a downlink signal transmitted by the base station, position information reported by the at least one terminal and position information of the at least one terminal measured by the base station.

In (b), the base station may determine the closeness between the nearby terminals of the at least one terminal based on a reception quality report reported by the other terminals of the at least one terminal with respect to an uplink signal or downlink signal transmitted by one of the at least one terminal. Here, the uplink signal or the downlink signal may be at least one of an uplink PUCCH signal transmitted by the one terminal and data using a designated uplink/downlink PRB. In this case, the base station may determine the closeness between the one terminal that has transmitted an uplink PUCCH and the other terminals by receiving, from the other terminals, reports on reception quality per sequence of the uplink PUCCH and a subframe ID that has received the uplink PUCCH transmitted by the one terminal. In this case, the base station may determine the closeness between the one terminal that has transmitted the data and the other terminals by receiving, from the other terminals, reports on reception quality of the data and a subframe ID that has received the data transmitted by the one terminal using the uplink or downlink PRB.

According to another example for achieving the object of the present invention described above, there is provided a method of operating a base station for UE relaying communication, including: identifying downlink channel quality information reported by a terminal and determining whether a nearby terminal needs to act as a relay, or receiving from the terminal a relay request of a nearby terminal; identifying nearby terminals of the terminal; selecting a relay terminal among the identified nearby terminals; requesting the selected relay terminal to act as a relay; setting a cellular link connection between the base station and the relay terminal and a D2D connection between the relay terminal and the terminal; and allocating wireless resources for a D2D link and cellular link for relaying in accordance with a request of the relay terminal or the terminal.

Here, the method may further include, after setting the cellular link connection and the D2D connection, identifying the closeness between the relay terminal and base stations and between the terminal and the base stations and the closeness between the relay terminal and other terminals close to the relay terminal and between the terminal and other terminals close to the terminal, wherein allocating the wireless resources may include allocating the wireless resources based on the identified closeness.

### [Advantageous Effects]

Using the above-described method of determining whether or not the D2D communication is possible between terminals and the above-described method of identifying other terminals close to terminals that perform the D2D communication according to the present invention, direct communication between adjacent terminals and UE relaying can be performed, and wireless resources used for the cellular link or other D2D links can be reused.

In addition, the variation of the link status depending on terminal mobility can be handled, and the D2D communication between a new UE and a legacy UE as well as between new UEs can be handled.

### DESCRIPTION OF DRAWINGS

FIG. 1 is a conceptual diagram illustrating the concept of direct D2D communication at which the present invention is aimed.

FIG. 2 is a conceptual diagram illustrating the concept of UE relaying communication at which the present invention is aimed.

FIG. 3 is a flowchart illustrating a direct D2D communication method according to the present invention.

FIG. 4 is a procedural diagram illustrating a method of confirming whether D2D communication between terminals belonging to two adjacent cells is possible in accordance with the present invention.

FIGS. 5 and 6 are conceptual diagrams illustrating the concept of wireless resource reuse for D2D communication according to the present invention.

FIG. 7 is a flowchart illustrating a method of UE relaying communication according to the present invention.

### MODES OF THE INVENTION

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” may refer to a mobile station (MS), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, and also portable units or terminals having a combination of such functions, but the present invention is not limited thereto.

The term “base station” used herein generally denotes a fixed or moving point communicating with a terminal, and may be referred to as a Node-B, evolved Node-B (eNB), base transceiver system (BTS), access point, relay, femtocell, and other terms.

With reference to the appended drawings, preferred embodiments of the present invention will be described in detail below. To aid in understanding the present invention, like numbers refer to like elements throughout the description of the figures, and the description of the same component will not be reiterated.

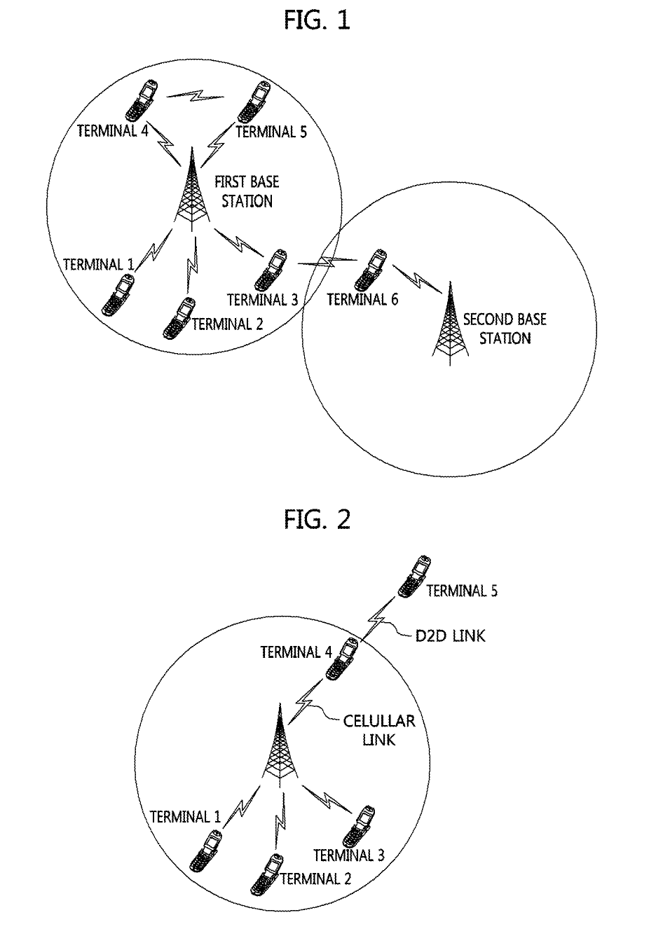

FIG. 1 is a conceptual diagram illustrating the concept of direct D2D communication at which the present invention is aimed.

Referring to FIG. 1, a cellular communication network is illustrated to include a first base station and a second base station. Here, terminal 1 to terminal 3 belonging to the cell created by the first base station perform communication through a typical connection link using the first base station, however, terminal 4 and terminal 5 belonging to the first base station perform direct data transmission and reception without the data passing through the base stations.

Various user cases may be discussed in which such direct D2D communication can be effectively used. For example, the direct D2D communication may be used for a local media server or the like which provides a large amount of data (e.g., program of a rock concert, information on musicians) to attendees participating in a rock concert or the like. At this time, each terminal may connect to a serving cell to perform telephone communication and Internet access using a typical cellular link while directly transmitting and receiving the large amount of data mentioned above in the D2D communication method with respect to the local media server that corresponds to the counterpart of the D2D communication.

Meanwhile, referring to FIG. 1 again, the D2D link may be created not only between terminals having the same cell as the serving cell but also between terminals having different cells as the serving cells. For example, terminal 3 belonging to the first base station may perform the D2D communication with terminal 6 belonging to the second base station.

FIG. 2 is a conceptual diagram illustrating the concept of UE relaying communication at which the present invention is aimed.

Referring to FIG. 2, terminal 1 to terminal 3 belonging to the cell created by the first base station perform communication through a typical connection link using the first base station, however, terminal 4 belonging to the first base station acts as a relay to terminal 5, and data transmitted from the base station to terminal 5 and data transmitted from terminal 5 to the base station are relayed through terminal 4. The overall relay is performed through a cellular link between the base station and the terminal (relay terminal) acting as the relay and a D2D link between the relay terminal and a terminal (end terminal) receiving the relaying service.

According to the UE relaying described above, transmission capacity of the terminal located at the cell boundary can be improved, and the frequency use efficiency of the entire cell can be enhanced through the frequency reuse in the D2D link.

In the embodiments of the method for direct D2D communication or UE relaying communication of the present invention to be described below, it is assumed that terminals performing the direct D2D communication and UE relaying communication belong to the same cells or different cells. Here, terminals performing the direct D2D communication and UE relaying communication are controlled by respective serving cells and perform data transmission and reception with the counterpart terminals, and adjacent cell base stations perform cooperation through information exchange if necessary.

Some or all of the terminals performing mutual communication using a D2D link may be terminals (i.e., new UE) that can recognize as their direct communication counterparts terminals other than the base station, and some thereof may be terminals (i.e., legacy UE) that cannot recognize terminals as their direct communication counterparts. New UEs refer to terminals that can perform not only typical uplink transmission and downlink reception but also uplink reception and/or downlink transmission in a cellular communication system, and legacy UEs refer to terminals that can only perform the uplink transmission and the downlink reception as is done in the existing UE.

Techniques to be described below include both the D2D communication between the new UEs and the D2D communication between the new UE and the legacy UE.

In the present invention, a direct D2D communication method, a method of confirming whether the D2D communication between two terminals is possible required for the direct D2D communication method, a method of identifying terminals close to the D2D communication terminals for wireless resource reuse, a UE relaying communication method, measures against variation of link status due to terminal mobility, and a D2D communication method between a new UE and a legacy UE, and so forth, will be described.

Meanwhile, the direct D2D communication method, the method of confirming whether the D2D communication between two terminals is possible required for the direct D2D communication method, the method of identifying terminals close to the D2D communication terminals for wireless resource reuse, the UE relaying communication method, the measures against variation of link status due to terminal mobility, and the D2D communication method between a new UE and a legacy UE will be individually described for convenience in this specification. However, it should be noted that the technical scope of the present invention includes not only the case where the three steps of the operating method described above are separately performed but also the case where some of the technical spirit constituting the three steps is combined and performed.

Direct D2D communication method

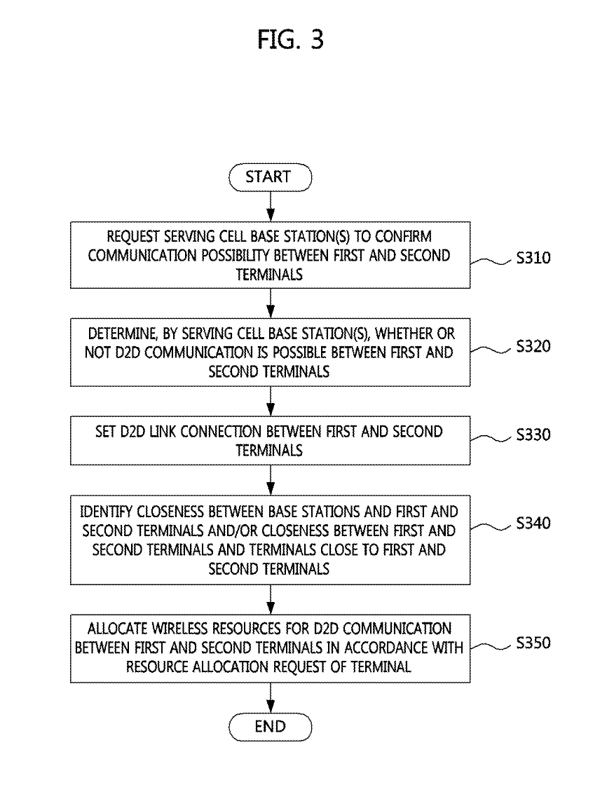

FIG. 3 is a flowchart illustrating a direct D2D communication method according to the present invention.

Referring to FIG. 3, the direct D2D communication method according to the present invention may include requesting, by a network, serving cell base station(s) of first and second terminals to confirm a D2D communication possibility between the first and second terminals in response to a connection setting request for a second terminal from a first terminal, or in accordance with self-determination of the network when the connection between the first and second terminals has been already created (S310), determining, by the serving cell base station(s), whether or not the D2D communication is possible between the first and second terminals (S320), setting the D2D connection between the first and second terminals (S330), identifying the closeness between the base station and the first and second terminals and the closeness between the first and second terminals and terminals close to the first and second terminals (S340), and allocating wireless resources for the D2D communication between the first and second terminals based on the identified closeness in accordance with a resource allocation request of at least one of the first and second terminals (S350).

First, in step S310, the first terminal may request the D2D connection setting for the second terminal from the network using a typical method. That is, in step S310, the first terminal requests the call connection to the second terminal from the network in accordance with a typical connection setting request procedure. However, the next step (S320) may be performed by self-determination of the network when the connection between the two terminals has been already set through the network or when the two terminals belong to the same cell or different adjacent cells due to terminal mobility.

In step S310, the network determines whether the first and second terminals belong to the same cell or adjacent cells, and requests the base station of the serving cell of the first and second terminals (or two base stations of the corresponding serving cells when the first and second terminals belong to different adjacent cells) to confirm the D2D communication possibility between the two terminals.

Next, in step S320, the corresponding serving cell base station(s) determines whether or not the D2D communication is possible between the two terminals. To this end, the corresponding base station(s) may instruct the corresponding terminal(s) to perform measurement for determining whether or not the D2D communication is possible between the two terminals, and the corresponding terminal(s) may perform the instructed measurement and report the measurement result to the base station. At this time, when it is necessary to determine whether or not the D2D communication is possible between the two terminals belonging to two adjacent cells, information exchange between the corresponding base stations may be required. Step S320 will be described later.

Next, in step S330, when it is determined by the report of the terminal(s) that the D2D communication between the two terminals is possible, this is reported to the network by the corresponding base station, and the D2D connection between the two terminals is set in accordance with the instruction of the network.

Next, in step S340, the closeness between the base station and the first and second terminals and the closeness between the first and second terminals and terminals close to the first and second terminals are identified. This is because it is necessary to identify what terminals are located close to the two terminals performing the D2D communication for frequency reuse with other cellular links or other D2D links. However, step S340 may be performed prior to step S330 of setting the D2D connection between the two terminals, and may not be performed in accordance with the determination of the base station or when another means for frequency reuse is applied. Step S340 will be described later with reference to FIGS. 5 and 6.

Next, in step S350, the corresponding base station allocates wireless resources for the D2D communication between the two terminals in accordance with the request of the terminal having data to be transmitted, and the two terminals perform the D2D communication using the allocated wireless resources. Method of confirming whether or not D2D communication is possible Step 5320 of determining, by the corresponding base station, whether or not the D2D communication is possible is performed based usually on geographical closeness between the two terminals trying to set the D2D link or the closeness in terms of the signal transmission, and the determination may be made using the following methods.

1) Positioning method

The positioning method is to use geographical position information of each terminal. The simplest positioning method includes notifying the network of position information obtained using a satellite positioning device such as satellite GPS/Galileo provided in each terminal and confirming the notified position information. That is, the position information of both terminals of the D2D link to be set is checked to confirm whether the two terminals are located within a D2D communication-enabled distance. When the terminal does not have the positioning device, the geographical position information of the terminal tracked using a cell ID positioning scheme, an Observed Time Difference of Arrival (OTDOA) scheme, an Uplink Time Difference of Arrival (UTDOA) scheme or the like may be used.

In addition, downlink channel status feedback information, uplink channel status information resulting from sounding reference signal reception, reception quality of a signal received from adjacent base stations that each terminal measures and reports for handover or the like may be used to indirectly estimate the geographical positions of the two terminals.

2) Method of transmitting and receiving SRS between terminals

In the cellular system, the base station receives a periodic or nonperiodic sounding reference signal (SRS) transmitted from the terminal to obtain the uplink channel status information. Therefore, the base station notifies one of the two terminals of information associated with the SRS transmission of the other terminal, that is, period, offset, transmission bandwidth and position, SRS sequence, transmitting power and the like, and the terminal that receives the corresponding SRS signal using such information reports to the serving cell the reception quality of the received SRS or whether or not the D2D communication is possible, so that the serving cell can confirm the closeness between the two terminals.

Another method includes instructing one of the two terminals to perform separate uplink SRS transmission for confirming the closeness, and notifying the other terminal of the information associated with the corresponding SRS transmission, so that the terminal that receives the SRS can report to the serving cell the reception quality of the received SRS or whether or not the D2D communication is possible, and the serving cell can confirm the closeness between the two terminals.

Here, in the case of the terminal located at the cell boundary, it becomes problematic that the terminal also receives the signal from a terminal in an adjacent cell. To handle this, the terminal may cooperate with the adjacent cell base station to apply a sequence that can reduce the inter-cell interference, not to allocate the same wireless resources as the SRS for confirming the closeness to the adjacent cell, or not to allocate the corresponding wireless resources to the terminal located at the cell boundary of the adjacent cell or the adjacent cell terminal close to the terminal that should receive the corresponding SRS.

3) Method of transmitting and receiving data between terminals

Uplink or downlink wireless resources may be allocated to one of two terminals to cause the terminal to transmit predetermined data, and the other terminal may be informed of the allocated uplink or downlink wireless resources, transmission parameters, and so forth, so that the reception quality of the data received in the allocated wireless resources or whether or not the D2D communication is possible can be reported to the serving cell. The data transmitted through the allocated uplink or downlink wireless resources may be configured to be suitable for quality measurement.

Meanwhile, when the uplink wireless resources are used for the data transmission, it becomes problematic that the terminal located at the cell boundary also receives the signal from a terminal in an adjacent cell. To handle this, the terminal may cooperate with the adjacent cell base station to apply a sequence that can reduce the inter-cell interference, not to allocate the same wireless resources as those allocated for data for confirming the closeness, or not to allocate the corresponding wireless resources to the terminal located at the cell boundary of the adjacent cell or the adjacent cell terminal close to the terminal that should receive the corresponding data. In addition, when the downlink wireless resources are used, it becomes problematic that the terminal located at the cell boundary also receives the signal from the adjacent cell base station and interferes with terminals located at the cell boundary of the adjacent cell. To handle this, the terminal may cooperate with the adjacent cell base station to apply a sequence that can reduce the inter-cell interference, not to allocate the same wireless resources as those allocated for data for confirming the closeness, or not to allocate the corresponding wireless resources to the terminal located at the cell boundary of the adjacent cell or the adjacent cell terminal close to the terminal that should transmit the corresponding data.

In methods 2) and 3) described above, in order to determine whether the D2D communication is possible through SRS or data transmission and reception between terminals belonging to two different adjacent cells, the corresponding cell base stations require mutual information exchange for determining wireless resources and transmission parameters for transmission of an SRS or measurement data and delivering the measurement result.

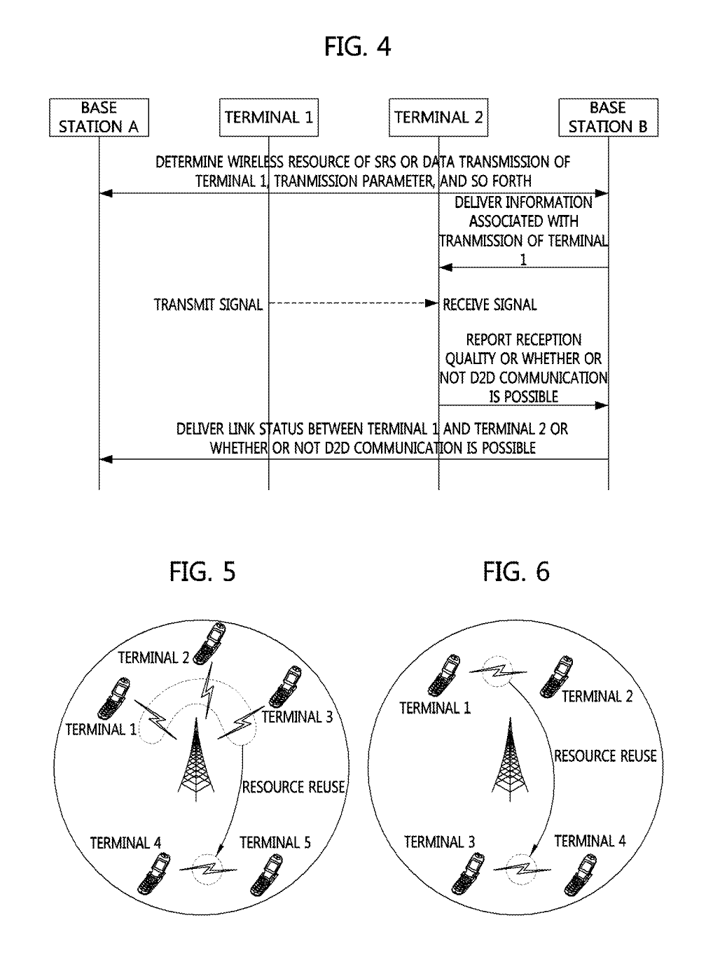

FIG. 4 is a procedural diagram illustrating a method of confirming whether the D2D communication between terminals belonging to two adjacent cells is possible in accordance with the present invention.

Referring to FIG. 4, a serving cell base station (base station A) of a terminal (terminal 1) that has requested connection setting and a base station (base station B) of a cell to which a connection request target terminal (terminal 2) belongs determine wireless resources and transmission parameters associated with the SRS or predetermined data transmission, which may be determined and delivered to base station B by base station A or may be determined by the cooperation between the two base stations. Base station B delivers the corresponding information to terminal 2 to instruct terminal 2 to receive the

SRS or the predetermined data, and using the information, terminal 2 reports to base station B the reception quality of the SRS or the predetermined data or whether or not the D2D communication is possible, which is then delivered to base station A by base station B.

Using methods including the three methods described above, the serving cell base station may measure the transmission quality of the link between two terminals (the first terminal and the second terminal) and identify whether or not the two terminals are close to each other, so that whether or not the D2D communication is possible can be determined Meanwhile, the reported reception quality may also be used to determine the transmission mode for a D2D link to be described later.

In step S350 of determining the resources allocated to the D2D link, an algorithm of maximizing a sum rate may be used to determine whether to reuse the wireless resources of the cellular link or other D2D links or to use resources orthogonal to the cellular link and the other D2D links as the allocated resources for the D2D link (the concept of reusing the wireless resources and a method of determining the wireless resources to be reused will be described later).

Meanwhile, a method of determining whether the wireless resources of the cellular link or other D2D links can be reused as the resources to be allocated to the D2D link and the method of determining the resources to be reused in step S350 of determining the resources to be allocated to the D2D link will be described later.

FIG. 5 is a conceptual diagram illustrating the concept of allocating resources for a D2D link according to the present invention.

Referring to FIG. 5, in the method of setting the D2D link according to the present invention, the concept of reusing the wireless resources of the cellular link (i.e., the link between the base station and the terminal 1, terminal 2 and terminal 3) as the resources of the D2D link (i.e., the link between terminal 4 and terminal 5) is illustrated. That is, the wireless resources for the cellular link communicating with the base station may be reused as the resources for the D2D link in consideration of the mutual interference, optimization of the transmission capacity of the entire cell, and so forth.

FIG. 6 is a conceptual diagram illustrating the concept of resource allocation for a D2D link according to the present invention.

Referring to FIG. 6, the concept of reusing the resources used for the D2D link of terminal 1 and terminal 2 as D2D link resources for terminal 3 and terminal 4 is illustrated. That is, when terminals are geographically spaced away from each other, the same resources may be allocated to at least two D2D links.

Method of identifying other terminals close to D2D communication terminal

In order to implement the resource allocation illustrated in FIGS. 5 and 6 by way of example, closeness information between the base station and terminals and closeness information between the terminals are required.

That is, in order to reuse the wireless resources of the cellular link or other D2D links as the allocation resources for the D2D link, the procedure (step S340) of identifying the closeness between base stations and terminals trying to perform the D2D communication and identifying the closeness between the terminals trying to perform the D2D communication and other terminals (including other D2D communication terminals) must be performed in advance.

The closeness between the base stations and the terminals trying to perform the D2D communication may be identified using the downlink channel status feedback information, uplink channel status information resulting from SRS reception, and the signal strength from adjacent base stations that each terminal measures and reports for handover or the like. Such report or measurement may be performed in a periodic or aperiodic way regarding all terminals in a connected state, and required report or measurement may be performed in this step, S340. The closeness between the base stations and the terminals may also be identified based on the position information on the terminals measured by the network.

In order to identify the closeness between the terminals trying to perform the D2D communication and other terminals, the following various methods may be used.

First, a method of using geographical position information of each terminal identified by a base station may be used. For example, using a positioning scheme, the base station may identify the closeness between terminals and the closeness between the base station and the terminals. In this case, the positioning scheme may be performed at a point in time at which resource determination is required, but when the base station periodically identifies positions of the terminals and the positions of the respective terminals are managed by the network or the base station, the information that has been already collected may be used.

In addition, using downlink channel status feedback information, uplink channel status information resulting from SRS reception, and the signal strength from adjacent base stations that each terminal measures and reports for handover or the like, geographical positions of the two terminals may be indirectly estimated and used.

Second, a method of using an uplink PRB reception quality report may be used. The base station may instruct two terminals (or one terminal) to report the PRB-specific reception quality of all the (or specific) uplink PRBs of specific subframe(s) that other terminals transmit or to report the reception quality by designating the (maximum) number of the subframes of which the reception quality is to be reported. In this case, as the method of reporting the reception quality, a method of reporting the reception quality for all the PRBs in a bitmap manner along with the ID of the corresponding subframe (e.g., transmitting n bit values per PRB) and a method of only reporting the PRB reception quality of a predetermined level or above may be used. The base station may refer to the scheduling history using the subframe ID and the PRB ID and identify the terminal that has performed the uplink transmission in the corresponding PRB, so that the closeness between the terminals trying to perform the D2D communication and other terminals may be confirmed in terms of link quality.

Third, a method of using a reception quality report per sequence of an uplink control channel may be used.

The base station may instruct one or both of two terminals to report the reception quality per sequence of all the (or specific) uplink control channels of specific subframe(s), for example, a physical uplink control channel (PUCCH) in a 3rd Generation Partnership Project (3 GP) Long-Term Evolution (LTE) system, or to report the reception quality by designating the (maximum) number of subframes of which the reception quality is to be reported.

For reference, the PUCCH, that is, the uplink control channel in the 3GPP LTE system, may be transmitted using 12 cyclic shift (CS) values for 12 frequency domain CAZAC sequences, which is specified by the cell-specific base index and the cell-specific symbol hopping (the CS is changed per OFDM symbol). In addition, the entire PUCCH channel consists of three domains, that is, channel quality indicator (CQI), semi-persistent ACK/NACK (e.g., statistical process control (SPC)) and scheduling request (SR), and dynamic ACK/NACK (i.e., PRB and CS). Here, domain separation is delivered by system information (SI), and one CQI (CQI, RI, PMI) is transmitted for one frequency domain CAZAC sequence. In addition, ACK/NACKs or SRs are transmitted up to three for one CAZAC sequence. In this case, the time domain spread sequence is applied so that an orthogonal code having a length of 4 is applied to the data portion and an orthogonal code having a length of 3 is applied to the RS portion. In addition, the dynamic ACK/NACK is automatically mapped by the physical downlink control channel (PDCCH) control channel element (CCE) index.

Therefore, the reception quality report per PUCCH sequence may be configured so that the reception quality per sequence of each domain (CQI corresponds to the frequency domain sequence, and ACK/NACK and SR correspond to the time domain sequence) or some domains (e.g., excluding the CQI domain) is transmitted along with the ID of the corresponding subframe.

The base station can use the subframe ID and frequency and time domain sequences to identify the terminal that has transmitted the corresponding control information, so that the closeness between the terminals trying to perform D2D communication and other terminals may be confirmed in terms of link quality.

Fourth, a method of using local broadcast and a reception quality report may be used.

The base station may instruct one or both of two terminals to transmit data at a specific subframe, and may instruct all other active terminals to report the channel status or the reception quality when the reception quality of the corresponding data signal is a predetermined level or above. In this way, the closeness between the base station and the other active terminals may be confirmed in terms of link quality.

The adjacent cell interference caused when the D2D communication terminal is located at a cell boundary may be handled as described in the method of confirming whether or not the D2D communication is possible. That is, the base station may cooperate with the adjacent cell base station to apply a sequence that can reduce the inter-cell interference, not to allocate the same wireless resources as those allocated for the local data broadcast to the adjacent cell, or not to allocate the corresponding wireless resources to the terminal located at the cell boundary of the adjacent cell or the terminal close to the D2D communication terminal that transmits (in the case of using the uplink resources for the local broadcast) or receives (in the case of using the downlink resources for the local broadcast) the corresponding data. In addition, as described in the method of confirming whether or not the D2D communication is possible, the base station and the adjacent cell base station require mutual information exchange to determine the wireless resources, transmission parameters, and so forth, for the local broadcast and deliver the measurement result.

Meanwhile, the fourth method may also be used for the method of identifying whether or not the D2D communication is possible. When the fourth method is used during the procedure of identifying whether or not the D2D communication is possible, the identification of whether or not the D2D communication is possible and the identification of the terminals close to the D2D communication terminals may be performed at the same time.

Fifth, a method of using the reception quality report of the terminal on the PRB of the downlink/uplink band used in another D2D link that has been already set may be used. The base station may instruct two terminals (or one terminal) to be set for the D2D link to report the reception level of the uplink/downlink PRB for the other D2D link of a specific subframe(s) that has been already connected. At this time, when semi-persistent scheduling (SPS) is applied to the D2D link to be measured, it is necessary to transmit and receive dummy data in consideration of the SPS applied to the D2D link even if there is no data to be transmitted through the corresponding D2D link. In this way, it is possible to confirm whether or not the two terminals are close to another D2D terminal pair using the downlink/uplink resources. That is, the fifth method may be used to implement the frequency reuse concept between the D2D links as described with reference to FIG. 6.

If necessary, some or all of the methods described above may be used to identify the closeness between terminals trying to perform D2D communication and other terminals. In the case of the direct D2D communication, it is possible to determine whether to reuse the same frequency resources as the cellular link or another D2D link based on such closeness information and the link status information associated with each cell.

Method of relaying data by UE

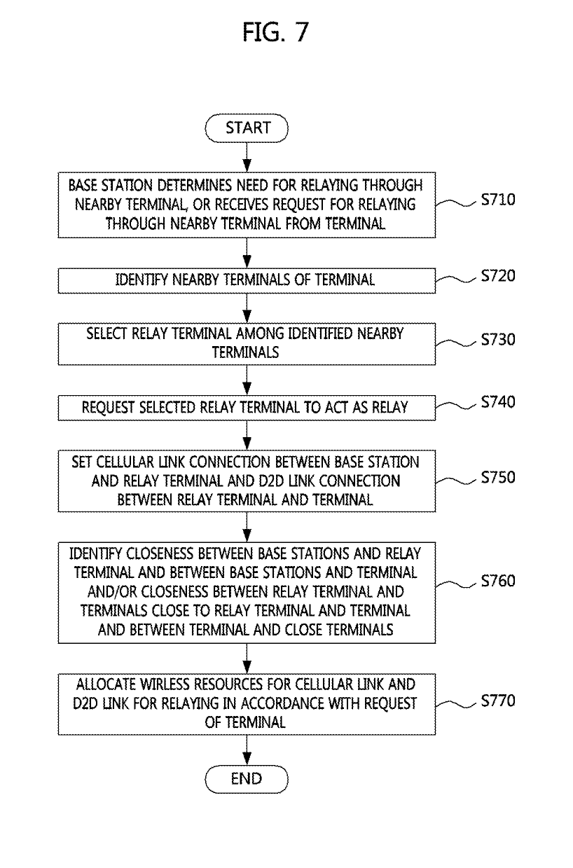

FIG. 7 is a flowchart illustrating a method of setting connection for UE relaying communication, that is, for allowing a terminal to relay data of another terminal according to the present invention.

Referring to FIG. 7, the data relaying method of UE according to the present invention may include confirming, by a base station, downlink channel status information reported by a terminal and determining the need for relaying through a nearby terminal, or receiving from the terminal a request for the relaying through a nearby terminal (S710), confirming nearby terminals of the terminal (S720), selecting a relay terminal among the confirmed nearby terminals (S730), requesting the selected relay terminal to act as a relay (S740), setting a cellular link connection between the base station and the relay terminal and a D2D connection between the relay terminal and the terminal (S750), identifying the closeness between the relay terminal and terminals close to the relay terminal and the terminal and between the terminal and the close terminals and the closeness between base stations and the relay terminal and between the base stations and the terminal (S760), and allocating wireless resources for the cellular link and D2D link for relaying in accordance with the request of the relay terminal or the terminal (S770).

First, in step S710, it is determined whether the serving cell base station needs to perform communication with the corresponding terminal through relaying based on the channel status information reported by the terminal on the downlink signal transmitted by the serving cell base station or based on the reception quality of the SRS transmitted by the terminal and received by the base station. In addition, in step S710, the terminal may request the relaying communication that causes a nearby terminal to act as the relay from the serving cell base station. That is, the UE relaying communication differs from the direct D2D communication. In the case of the direct D2D communication, the terminal typically designates a counterpart terminal and requests the D2D connection setting, however, in the case of the UE relaying communication, the procedure of identifying, by the base station, the terminal to act as the relay upon request of the terminal or determination of the base station is performed in advance and then the identified terminal becomes the suitable counterpart terminal of the D2D link.

Next, when it is determined in step S710 that the relaying communication through the nearby terminal is required or the relaying communication through the nearby terminal is requested by the terminal, step S720 of identifying, by the serving cell base station, nearby terminals of the corresponding terminal is performed.

At this time, in step S720, various methods belonging to the method of identifying the closeness between the D2D communication terminal and other terminals in step S340 described above with reference to FIG. 3 may be used to identify the nearby terminals close to the corresponding terminal

Next, in step S730, a terminal suitable to act as the relay is selected among the nearby terminals identified in step S720. In this case, it is preferable to select the terminal acting as the relay which has better reception quality of the signal received from the base station and is closer to the base station than the terminal typically performing transmission and reception through relaying.

Therefore, in order to select the terminal to act as the relay among the nearby terminals, the channel status information reported by the terminal, the reception quality of the SRS transmitted by the terminal and received by the base station, position information of the terminals, and so forth, may be used in step S730.

Next, in step S740, the serving cell base station requests the terminal selected as the relay terminal to act as the relay in accordance with the instruction of the network, and receives a response to the request. The terminal that is requested to act as the relay terminal may deny such a request, however, when the terminal has been already designated to act as the relay terminal in accordance with a predetermined rule, the terminal may not have a right to deny such a request. Therefore, in this case, the procedure of receiving the response to the request may be omitted.

Next, in step S750, the serving cell base station is instructed by the network to set the cellular link connection between the base station and the relay terminal and the D2D connection between the relay terminal and an end terminal

Next, in step S760, the closeness between the relay terminal and terminals close to the relay terminal and the end terminal and between the end terminal and the close terminals, and the closeness between the relay terminal and base stations and between the end terminal and the base stations are identified. The closeness between the terminal and the terminals close to the terminal has already been performed in step S720, and thus may be omitted. Here, various methods used in step S340 described with reference to FIG. 3 may be used to confirm nearby terminals close to the corresponding terminals and the closeness between base stations and the corresponding terminals. However, step S760 may be performed prior to step S750, or may not be performed in accordance with the determination of the base station or when another means for frequency reuse is applied.

Last, in step S770, wireless resources for the corresponding cellular link and D2D link are allocated in accordance with the request of the terminal when the terminal has data to transmit or in accordance with self-determination of the base station when the base station has data to transmit to the terminal, and then the allocated wireless resources are used to relay data from/to the end terminal.

Measures against variation of link status depending on terminal mobility

The D2D link status (e.g., distance, signal quality) between terminals may change over time due to relative movement of the terminals performing D2D communication through the D2D link. According to the change, interference on the cellular link or other D2D links caused by the D2D link may also change.

In particular, in the case of the UE relaying, the status of the cellular link as well as the status of the D2D link is changed so that the terminal acting as the relay may be changed. Therefore, it is necessary to determine whether or not the D2D communication connection can be continued and reallocate dynamic resources.

In the case of the direct D2D communication, the following methods can be used to handle the variation of the link status depending on the mobility of the terminals performing communication through the D2D link.

1) Whether or not D2D connection can be continued may be determined by the quality of the communication between D2D terminals.

2) The closeness between terminals may be determined by the periodic position identification between the terminals.

3) The method applied in step S340 described above may be periodically used to identify the closeness between specific D2D communication terminals and other terminals (including other D2D communication terminals) in consideration of the terminal mobility.

In the case of the UE relaying communication, to handle the variation of the link status depending on the mobility of the terminals performing communication through the D2D link, whether or not to change the relay terminal may be determined by the D2D link communication between the relay terminal and the end terminal.

In addition, identification of the closeness between the relay and end terminals and other cellular link terminals and the closeness between pairs of relay and end terminals is the same as in the case of direct D2D communication.

Method of D2D communication between new UE and legacy UE

Thus far, the method of D2D communication between new UEs has been described, however, it may also be assumed that one of two terminals performing D2D communication is a legacy UE (it is of course not possible to perform the D2D communication when both terminals are legacy UEs).

(1) Method of confirming whether or not D2D communication is possible between new UE and legacy UE

The base station may be configured to request SRS transmission or uplink transmission from the legacy UE and instruct the new UE to perform reception and report reception quality. In this case, information associated with the SRS transmission (resource and sequence) of the counterpart terminal is provided to the new UE. In this way, whether or not the two terminals are close to each other, that is, whether or not the D2D connection is possible, may be confirmed.

(2) Method of identifying other terminals close to legacy UE and new UE trying to perform D2D communication

The above-described method of confirming the closeness between the D2D communication terminals and other terminals may be used.

In addition, when the new UE acts as the relay terminal, UE relaying is also possible.

While the present invention has been described above with reference to the above-described embodiments, it will be understood by those skilled in the art that that various changes, substitutions and alterations may be made herein without departing from the spirit and scope of the invention as defined in the following claims.

1. A method of operating a network for direct device-to-device (D2D) communication, comprising:
(a) requesting, by the network, serving cell base station(s) of first and second terminals to confirm D2D communication possibility between the first and second terminals in response to a connection setting request for the second terminal from the first terminal, or in accordance with self-determination of the network when a connection between the first and second terminals has been already created;
(b) determining, by the serving cell base station(s), whether or not the D2D communication between the first and second terminals is possible;
(c) setting a D2D connection between the first and second terminals;
(d) identifying closeness between the first and second terminals and base stations and closeness between the first and second terminals and terminals close to the first and second terminals; and
(e) allocating wireless resources for the D2D communication between the first and second terminals based on the closeness identified in (d) in accordance with a resource allocation request of at least one of the first and second terminals.

2. The method of claim 1, wherein (b) determining whether or not the D2D communication between the first and second terminals is possible includes determining whether or not the D2D communication between the first and second terminals is possible based on the closeness between the first and second terminals.

3. The method of claim 2, wherein the closeness between the first and second terminals is determined based on at least one of position information reported by the first and second terminals, position information of the first and second terminals measured by the network, reception quality information of a sounding reference signal (SRS) that is transmitted by one of the first and second terminals and received by the other of the first and second terminals, and reception quality information that is reported by one of the first and second terminals on data transmitted through an uplink or downlink physical resource block (PRB) by the other of the first and second terminals.

4. The method of claim 1, wherein in (d), the closeness between the base stations and the first and second terminals is identified based on at least one of reception quality information of the terminals with respect to a downlink signal transmitted by the base station, uplink channel status information of the SRS received from the terminal, and reception quality information of a signal from adjacent base stations that is measured and reported by each terminal for handover, etc., or is identified based on position information reported to the base station by the terminals or position information measured on the terminal by the network.

5. The method of claim 1, wherein in (d), the closeness between the first and second terminals and the terminals close to the first and second terminals is identified using position information reported by the terminals or position information of the terminals measured by the network, or is identified by the network based on reception quality reported to the network by one of the terminals with respect to data mapped to an uplink control channel sequence and/or uplink PRB and transmitted by the other terminal or based on reception quality reported to the network by one of the terminals with respect to data mapped to a downlink PRB and transmitted by the other terminal.

6. The method of claim 1, wherein (e) allocating the wireless resources for the D2D communication includes receiving a reception quality report from at least one of the first and second terminals with respect to an uplink or downlink PRB allocated to another D2D link that has been already set, and determining the resources to be allocated to the D2D link based on the reported reception quality.

7. A method of operating a terminal used to identify whether or not D2D communication is possible and/or nearby terminals for direct D2D communication and UE relaying communication, comprising:
(a) receiving an uplink signal or a downlink signal transmitted by a counterpart terminal constituting a D2D link;
(b) reporting, to a base station, reception quality of the uplink signal or the downlink signal transmitted by the counterpart terminal; and
(c) receiving, from the base station, setting of the D2D link and resource allocation of the D2D link based on the reception quality reported to the base station.

8. The method of claim 7, wherein in (a), the uplink signal or the downlink signal transmitted by the counterpart terminal is at least one of an uplink SRS, an uplink physical uplink control channel (PUCCH) signal and data using a designated uplink/downlink PRB.

9. The method of claim 8, wherein in (b), when the terminal receives an uplink PUCCH transmitted by the counterpart terminal, reception quality per sequence of the PUCCH along with a subframe ID that has received the uplink PUCCH is reported to the base station.

10. The method of claim 8, wherein in (b), when the terminal receives the data using the uplink or downlink PRB transmitted by the counterpart terminal, a subframe ID that has received the data using the uplink or downlink PRB along with reception quality of the data is reported to the base station.

11. A method of determining D2D link resources of a serving cell base station for direct D2D communication and UE relaying communication, comprising:
(a) determining closeness between the base station and at least one terminal;
(b) determining closeness between nearby terminals of the at least one terminal; and
(c) determining the D2D link resources based on the information obtained in (a) and (b).

12. The method of claim 11, wherein (a) determining the closeness between the base station and the at least one terminal includes determining the closeness between the base station and the at least one terminal based on at least one of a reception signal quality report of the at least one terminal with respect to a downlink signal transmitted by the base station, position information reported by the at least one terminal and position information of the at least one terminal measured by the base station.

13. The method of claim 11, wherein in (b), the base station determines the closeness between the nearby terminals of the at least one terminal based on a reception quality report reported by the other terminals of the at least one terminal with respect to an uplink signal or downlink signal transmitted by one of the at least one terminal.

14. The method of claim 13, wherein the uplink signal or the downlink signal is at least one of an uplink PUCCH signal transmitted by the one terminal and data using a designated uplink/downlink PRB.

15. The method of claim 14, wherein in (b), the base station determines closeness between the one terminal that has transmitted an uplink PUCCH and the other terminals by receiving, from the other terminals, reports on reception quality per sequence of the uplink PUCCH and a subframe ID that has received the uplink PUCCH transmitted by the one terminal.

16. The method of claim 14, wherein in (b), the base station may determine closeness between the one terminal that has transmitted the data and the other terminals by receiving, from the other terminals, reports on reception quality of the data and a subframe ID that has received the data transmitted by the one terminal using the uplink or downlink PRB.

17. A method of operating a base station for UE relaying communication, comprising:
identifying downlink channel quality information reported by a terminal and determining whether a nearby terminal needs to act as a relay, or receiving from the terminal a relay request of a nearby terminal;
identifying nearby terminals of the terminal;
selecting a relay terminal among the identified nearby terminals;
requesting the selected relay terminal to act as a relay;
setting a cellular link connection between the base station and the relay terminal and a D2D connection between the relay terminal and the terminal; and
allocating wireless resources for a D2D link and cellular link for relaying in accordance with a request of the relay terminal or the terminal.

18. The method of claim 17, further comprising:
after setting the cellular link connection and the D2D connection, identifying closeness between the relay terminal and base stations and between the terminal and the base stations and the closeness between the relay terminal and other terminals close to the relay terminal and closeness between the terminal and other terminals close to the terminal,
wherein allocating the wireless resources includes allocating the wireless resources based on the identified closeness.
